(19) United States
(12) Patent Application Publication
(10) Pub. No.: US 2006/0274908 A1
(43) Pub. Date: Dec. 7, 2006

(54) Apparatus and method for displaying audio level

(75) Inventor: Byung Sun Choi, Suwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/446,978

(22) Filed: Jun. 6, 2006

(30) Foreign Application Priority Data
Jun. 7, 2005 (KR) 10-2005-0048439

(51) Int. Cl. H04R 5/02

(52) U.S. Cl. 381/306

(57) ABSTRACT

An apparatus and method for providing an audio level are discussed. According to one embodiment, the method includes generating a sum of outputs of channels in audio, weighting the sum according to the number of channels in the audio, and indicating an audio level of the audio according to the weighted sum.

This application claims the benefit of the Korean Patent Application No. 10-2005-0048439 filed on Jun. 7, 2005 in Republic of Korea, the entire contents of which are fully incorporated by reference.

### BACKGROUND OF THE INVENTION

1. Field of the Invention

The present invention relates to an apparatus and a method for displaying audio levels, and more particularly to an apparatus and a method for displaying the exact output levels of audio being played from a storage medium such as a Digital Versatile Disc (hereinafter, referred to as DVD).

2. Description of the Related Art

Recently, high capacity DVDs, which can store high quality audio data and video data, and karaoke discs, which can store high quality karaoke audio data, have been widely spread. In addition, various types of digital devices capable of playing audio data stored in DVDs or karaoke discs have been commercialized.

DVDs or karaoke discs may store audio data of either 2-channels or 5.1-channels. When a digital device plays any audio tune stored in the DVD, according to a user request, the digital device reproduces and outputs the audio over either the 2 or 5.1 channels according to the number of channels of the audio tune.

The digital device sums up the output of each channel in the output audio, and controls an audio level meter based on a value obtained by summing up the outputs of all the channels. For example, when the digital device plays 2-channel audio, the digital device sums up both the left channel (L-CH) audio output and the right channel (R-CH) audio output, and controls the audio level meter so that the audio level meter indicates and displays an audio level proportional to the value of the output sum. In this case, if the 2-channel audio has a high output sum, the index of the audio level meter will show a high level in the audio level meter. On the other hand, if the 2-channel audio has a low output sum, the index will show a low level in the audio level meter. Accordingly, a user can check the output level of the currently played audio visually by simply viewing the audio level meter.

However, when a general digital device plays multi-channel (more than 2 channel) audio such as 5.1 channel audio, the digital device sums up all the audio outputs from the 5.1 channels, and controls the audio level meter based on a value obtained by summing up these outputs. In this case, because there are many channels, the output sum value will be very high and thus the output sum value will often exceed the highest level that can be indicated by the audio level meter. In such a case, the audio level meter indicates only its highest level even though the actual audio output level is much higher than the highest level that the audio level meter is capable of indicating. Therefore, a user cannot determine accurately the exact output level of the currently played multi-channel audio using the audio level meter, because it will generally show the highest level at most of the time regardless of what the actual output level is.

### SUMMARY OF THE INVENTION

Accordingly, the present invention has been made to address the above-mentioned and other limitations and disadvantages associated with the related art.

It is an object of the present invention to provide a method and an apparatus for displaying the exact output levels of audio played in various channel modes including a 2 channel mode, a 5.1 channel mode, a 6.1 channel mode, a 7.1 channel mode, etc.

It is another object of the present invention to provide a method and apparatus for indicating an audio output level in a multi-channel (more than 2 channel) audio output device.

In order to achieve the above and other objects, in accordance with one aspect of the present invention, there is provided according to an embodiment a method for providing an audio level, the method comprising: generating a sum of outputs of channels in audio; weighting the sum according to the number of channels in the audio; and indicating an audio level of the audio according to the weighted sum.

In accordance with another aspect of the present invention, there is provided a method for providing an audio level, the method comprising: determining the number of channels in audio; and selectively weighting a sum of outputs of at least two channels out of all channels in the audio depending on the result of the determining step, so as to indicate an audio level of the audio.

In accordance with another aspect of the present invention, there is provided an apparatus for providing an audio level, the apparatus comprising: a level detector to generate a sum of outputs of channels in audio; a controller to weight the sum according to the number of channels in the audio; and an indicator to indicate an audio level of the audio according to the weighted sum.

In accordance with another aspect of the present invention, there is provided an apparatus for providing an audio level, the apparatus comprising: a controller to determine the number of channels in audio, and to selectively weight a sum of outputs of at least two channels out of all channels in the audio depending on the determined number of channels, so as to indicate an audio level of the audio.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a digital device according to an embodiment of the present invention is applied;

FIG. 2 is a block diagram illustrating the construction of a level sum detector in the digital device of FIG. 1 according to an embodiment of the present invention;

FIG. 3 is a flow diagram illustrating a method for displaying audio levels according to an embodiment of the present invention; and

FIG. 4 is a diagram illustrating a process for detecting the number of channels in audio based on navigation information according to an embodiment of the present invention.

### DETAILED DESCRIPTION OF PREFFERRED EMBODIMENTS

Hereinafter, preferred embodiments of the present invention will be described with reference to the accompanying drawings.

An apparatus and a method for displaying audio levels according to the present invention can be applied to various types of digital devices for playing audio data, which is encoded in various ways including 2 channels, 5.1 channels, 6.1 channels, 7.1 channels, etc., and stored in a recording medium such as a CD, DVD, etc.

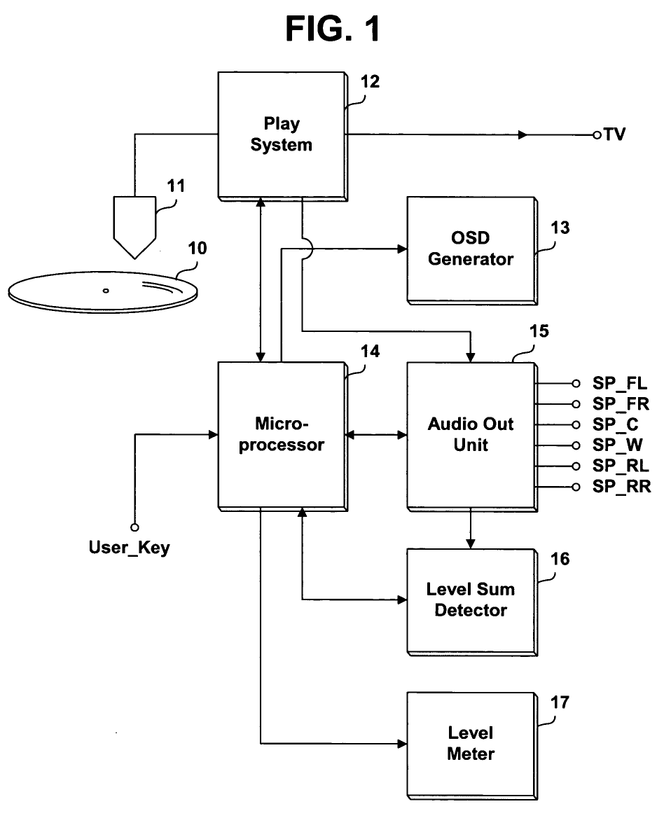

As illustrated in FIG. 1, a digital device such as a DVD player, a karaoke machine, etc. may include an optical pickup 11, a play system 12, an OSD (on screen display) generator 13, a microprocessor 14, an audio out unit 15 for outputting audio outputs from the multiple audio channels, a level sum detector 16, an audio level meter 17 for indicating an audio output level, etc. All the components of the digital device are operatively coupled. The optical pickup 11 can read a recording medium 10 such as an optical disc and can record data on the recording medium 10.

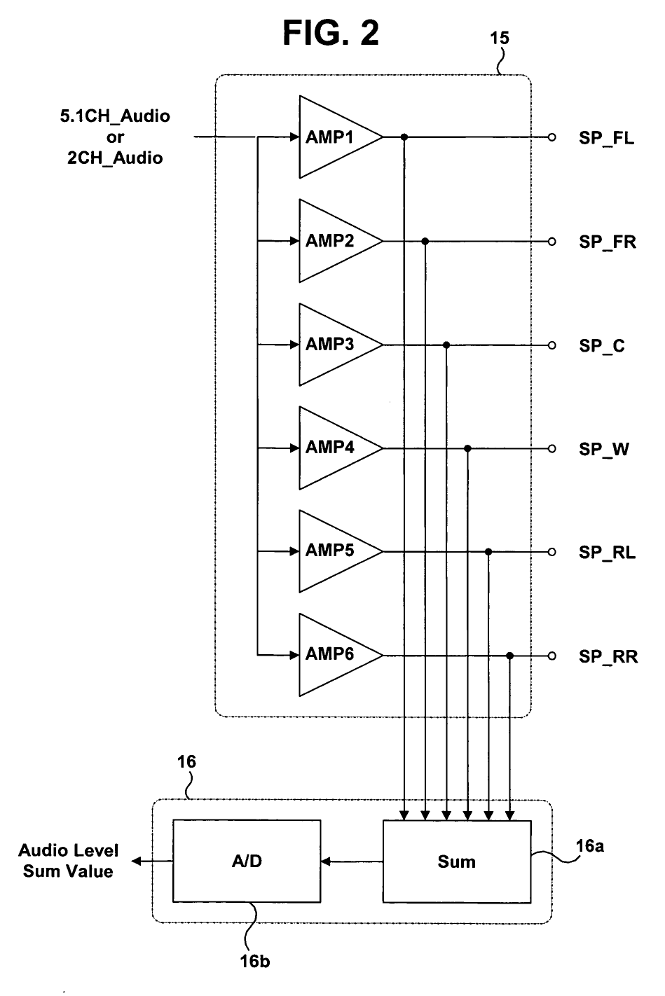

As illustrated in FIG. 2, the level sum detector 16 may include an adder 16a for summing up the audio output of each channel amplified and output by the audio out unit 15, and an Analog-to-Digital (A/D) converter 16b for converting the sum output from the adder 16a into a digital value and outputting the digital value to the microprocessor 14. In this example, the audio out unit 15 outputs the audio levels from the multiple channels, e.g., front left speaker channel (SP_FL), front right speaker channel (SP_FR), center speaker channel (SP_C), woofer channel (SP_W), rear left speaker channel (SP_RL), and rear right speaker channel (SP_RR).

The microprocessor 14 controls an operation of the play system 12 to play audio data/tunes stored in the optical disc 10 such as a DVD according to a user request. Herein, the audio out unit 15 amplifies the audio of each channel, which is played by the play system 12, and outputs the amplified audio.

The adder 16a adds up the audio outputs of all the audio channels, which are amplified and output by the audio out unit 15, and the A/D converter 16b converts the summed audio output into a digital summation value and outputting the digital summation value to the microprocessor 14.

The microprocessor 14 controls an operation of the level meter 17 according to the digital value received from the A/D converter 16b, and checks the number of channels in the played audio. If the played audio is 5.1 channel audio, the microprocessor 14 weights the digital value with a predetermined weight (e.g., 30%). If the played audio is 6.1 channel audio, the microprocessor 14 weights the digital value with another predetermined weight (e.g., value higher than 30%). Generally the predetermined weight value would be higher as the number of audio channels increases. Accordingly, the microprocessor 14 controls the indication by the audio level meter 17 based on the weighted digital summation value.

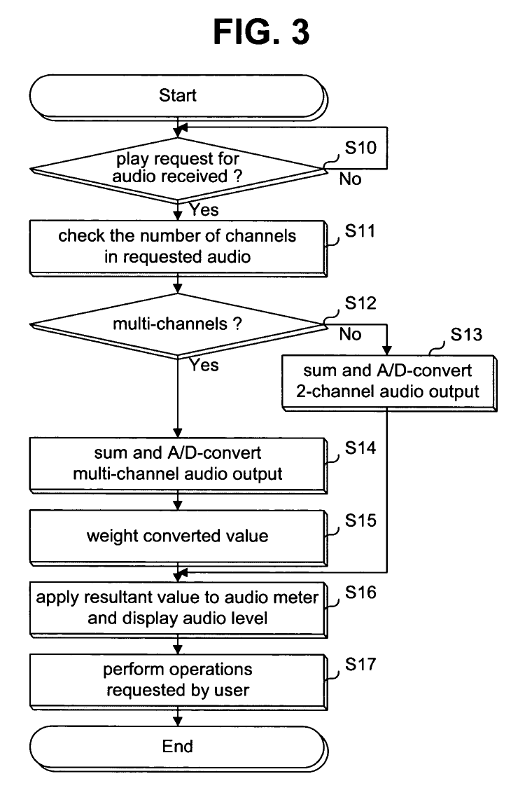

As a result, even when the multi-channel audio such as 5.1 channel audio is played, the indication value for the audio level meter 17 is modified in proportion to the output audio levels and the number of channels, and is displayed in a normal state between its lowest possible level and highest possible level to accurately reflect the current audio output level. Hereinafter, this will be described in detail with reference to FIG. 3.

FIG. 3 is a flow diagram illustrating a method for displaying audio levels according to an embodiment of the present invention. This method can be implemented in the digital device of FIGS. 1 and 2, but can be implemented in other device/system.

When a play request for an audio tune/data stored in the optical disc 10 is received from a user (S10), the microprocessor 14 controls the operation of the play system 12 and performs an audio play operation for reading and playing the requested audio tune from the optical disc 10.

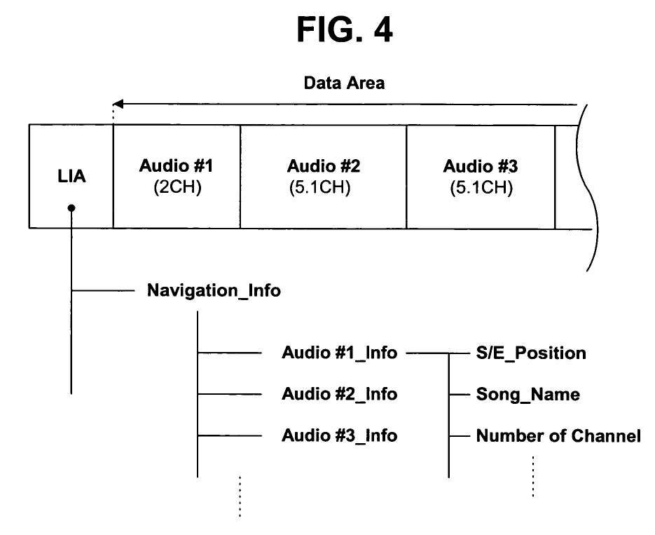

Herein, the microprocessor 14 checks the number of channels in the audio to be played (S11). For example, referring to FIG. 4 illustrating an example of a lead-in area (LIA) and a data area of the optical disc 10, the microprocessor 14 searches for an encoding scheme for the requested audio tune (Audio #), e.g. information (Audio #_Info), that indicates whether the requested audio tune has been encoded with 2 channels, 5.1 channels, etc. from navigation information written in a specific area such as the lead-in area (LIA) of the optical disc 10. That is, by examining the navigation information Navigation_Info (e.g., “Number of Channel”) stored on the optical disc 10, the microprocessor 14 can determine the number of channels involved in the audio to be played.

As a result of this checking, when the audio tune to be played is not multi-channel audio, but is 2 channel audio (S12), the level sum detector 16 sums up the left channel (L-CH) audio output and right channel (R-CH) audio output, which are amplified and output by the audio out unit 15, converts an audio level value obtained by summing up the audio outputs into a digital value, and outputs the digital value to the microprocessor 14 (S13).

The microprocessor 14 applies this digital audio level value to the level meter 17, thereby displaying or indicating the audio level of the output audio (S16).

On the other hand, if the microprocessor 14 checks that the audio tune to be played is multi-channel (greater than 2 channel) audio, e.g. 5.1 channel audio, based on the audio tune information included in the navigation information (S12), the level sum detector 16 sums up the audio outputs of the channels (e.g., 6 channels if the audio is 5.1 channel audio), which are amplified and output by the audio out unit 15, converts a value obtained by summing up the audio outputs into a digital value, and outputs the digital value to the microprocessor 14 (S14). As a variation, not all the outputs of all the channels may be summed by the level sum detector 16. For example, the level sum detector 16 may sum up only the outputs of several channels out of the 6 channels to generate the sum value.

The microprocessor 14 then weights this digital sum value with a predetermined weight (e.g., 30%) depending on the number of channels involved (S15), and applies the weighted value to the audio level meter 17, thereby displaying the audio level of the currently playing audio output (S16). Then, the microprocessor 14 performs operations requested by the user (S17).

Accordingly, even when the multi-channel audio such as 5.1 channel audio, 6.1 channel audio, 7.1 channel audio, etc. is played, the microprocessor 14 controls the digital sum value such that the audio level meter 17 displays audio levels in a normal state between its lowest possible level and highest possible level while reflecting accurately the variation of the actual output audio levels, similarly to the case in which the 2 channel audio is played. As a result, a user can recognize with accuracy the actual output levels of the multichannel audio through the index displayed on the level meter.

According to the present invention as described above, the index of a level meter, which indicates the output level of audio being reproduced, can indicate between the lowest level and the highest level while precisely reflecting the variations of audio output regardless of the encoding scheme of the played audio. Consequently, a user can recognize the actual output levels of the played audio through the index displayed on the level meter.

The preferred embodiments of the present invention have been described for illustrative purposes, and those skilled in the art will appreciate that various modifications, additions and substitutions are possible, without departing from the scope and spirit of the invention as disclosed in the accompanying claims.

What is claimed is:

1. A method for providing an audio level, the method comprising:
generating a sum of outputs of channels in audio;
weighting the sum according to the number of channels in the audio; and
indicating an audio level of the audio according to the weighted sum.

2. The method as claimed in claim 1, wherein in the generating step, the sum of the outputs is a sum of at least two channels out of all channels in the audio.

3. The method as claimed in claim 1, wherein the audio is a 5.1-channel audio, a 6.1-channel audio, or a 7.1-channel audio.

4. The method as claimed in claim 1, further comprising:
obtaining the number of channels in the audio from navigation information.

5. The method as claimed in claim 4, wherein the navigation information is stored in a lead-in area of a recording medium.

6. The method as claimed in claim 1, wherein the audio is recorded on a recording medium, and the method further comprises:
reproducing the audio from the recording medium while the indicating step indicates the audio level of the audio being reproduced.

7. The method as claimed in claim 1, wherein the generating step, the weighting step, and the indicating step are performed in a CD player, a DVD player or a karaoke machine.

8. A method for providing an audio level, the method comprising:
determining the number of channels in audio; and
selectively weighting a sum of outputs of at least two channels out of all channels in the audio depending on the result of the determining step, so as to indicate an audio level of the audio.

9. The method as claimed in claim 8, wherein in the selectively weighting step, the sum of the outputs is a sum of outputs of the all channels in the audio.

10. The method as claimed in claim 8, wherein the selectively weighting step includes:
weighting the sum of the outputs if the determining step determines that the number of the channels in the audio is greater than 2.

11. The method as claimed in claim 8, further comprising:
indicating the audio level of the audio according to the weighted sum if the determining step determines that the number of the channels in the audio is greater than 2.

12. The method as claimed in claim 11, further comprising:
indicating the audio level of the audio according to the non-weighted sum if the determining step determines that the number of the channels in the audio is not greater than 2.

13. The method as claimed in claim 8, wherein the audio is a 5.1-channel audio, a 6.1-channel audio, or a 7.1-channel audio.

14. The method as claimed in claim 8, further comprising:
obtaining the number of channels in the audio from navigation information.

15. The method as claimed in claim 14, wherein the navigation information is stored in a lead-in area of a recording medium.

16. The method as claimed in claim 11, wherein the audio is recorded on a recording medium, and the method further comprises:
reproducing the audio from the recording medium while the indicating step indicates the audio level of the audio being reproduced.

17. The method as claimed in claim 8, wherein the determining step and selectively weighting step are performed in a DVD player or a karaoke machine.

18. An apparatus for providing an audio level, the apparatus comprising:
a level detector to generate a sum of outputs of channels in audio;
a controller to weight the sum according to the number of channels in the audio; and
an indicator to indicate an audio level of the audio according to the weighted sum.

19. An apparatus for providing an audio level, the apparatus comprising:
a controller to determine the number of channels in audio, and to selectively weight a sum of outputs of at least two channels out of all channels in the audio depending on the determined number of channels, so as to indicate an audio level of the audio.

20. The apparatus as claimed in claim 19, wherein the controller weights the sum of the outputs if the number of the channels in the audio is greater than 2.
